(19) United States
(12) Patent Application Publication
(10) Pub. No.: US 2026/0247104 A1
(43) Pub. Date: Aug. 20, 2026

(54) METHOD AND APPARATUS FOR PERFORMING WIRELESS COMMUNICATION

(71) Applicant: LG Electronics Inc., Seoul (KR)

(72) Inventors: Myoungseob KIM, Seoul (KR); Jaihyun BYUN, Seoul (KR)

(21) Appl. No.: 19/489,506

(22) PCT Filed: Jun. 3, 2024
(86) PCT No.: PCT/KR2024/007584

§ 371 Date: Dec. 2, 2025

(30) Foreign Application Priority Data
Jun. 2, 2023 (KR) 10-2023-0071433

(51) Int. Cl. H04W 4/02; H04W 4/40; H04W 64/00

(52) U.S. Cl. CPC H04W 4/027; H04W 4/40; H04W 64/006

(57) ABSTRACT

A method whereby a first device communicates wirelessly and a device supporting same are provided. For example, the first device may obtain a first message including information about a predicted free space of a first entity. For example, the first device may generate a second message related to activation of the first device on the basis of the first message. For example, the first device may execute the activation of the first device.

### TECHNICAL FIELD

This disclosure relates to a wireless communication system.

### BACKGROUND ART

5G NR is a successor technology to long term evolution (LTE) and is a new clean-slate mobile communication system with characteristics such as high performance, low latency, high availability, etc. 5G NR may utilize all available spectrum resources, including low-frequency bands below 1 GHz, mid-frequency bands between 1 GHz and 10 GHz, high-frequency (millimeter wave) bands above 24 GHz, etc.

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, (vii) connected intelligence with machine learning capacity, etc. The vision of the 6G system may include four aspects such as intelligent connectivity, deep connectivity, holographic connectivity and ubiquitous connectivity, and the 6G system may satisfy the requirements shown in Table 1 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

### DISCLOSURE

### Technical Solution

In an embodiment, a method for a first device to perform wireless communication is provided. For example, the first device may obtain a first message including information related to a predicted free space of a first entity. For example, the first device may generate a second message related to a maneuver of the first device based on the first message. For example, the first device may execute the maneuver of the first device.

### BRIEF DESCRIPTION OF THE DRAWINGS

FIG. 1 shows a communication structure providable in a 6G system, based on an embodiment of the present disclosure.

FIG. 2 shows an electromagnetic spectrum, based on an embodiment of the present disclosure.

FIG. 3 shows an example of an NTN typical scenario based on a transparent payload, based on an embodiment of the present disclosure.

FIG. 4 shows an example of an NTN typical scenario based on a regenerative payload, based on an embodiment of the present disclosure.

FIG. 5 shows an example of a sensing operation, based on an embodiment of the present disclosure.

FIG. 6 is a drawing for describing V2X communication based on NR, compared to V2X communication based on RAT used before NR, based on an embodiment of the present disclosure.

FIG. 7 shows an example of a method for determining whether passage through an intersection section is possible, based on an embodiment of the present disclosure.

FIG. 8 shows an example of a method for determining whether passage through an intersection section is possible, based on an embodiment of the present disclosure.

FIG. 9 shows an example of a method for determining whether passage through an intersection section is possible, based on an embodiment of the present disclosure.

FIG. 10 shows an example of a method for determining whether passage through an intersection section is possible, based on an embodiment of the present disclosure.

FIG. 11 shows an example of a method for determining whether passage through an intersection section is possible, based on an embodiment of the present disclosure.

FIG. 12 shows an example of information included in a message, based on an embodiment of the present disclosure.

FIG. 13 shows an example of information included in a message, based on an embodiment of the present disclosure.

FIG. 14 shows an example of information included in a message, based on an embodiment of the present disclosure.

FIG. 15 shows an example of information included in a message, based on an embodiment of the present disclosure.

FIG. 16 (FIG. 16a, FIG. 16b) shows an example of a method for controlling a maneuver in an intersection based on a message, based on an embodiment of the present disclosure.

FIG. 17 shows an example of a method for controlling a maneuver in an intersection based on a message, based on an embodiment of the present disclosure.

FIG. 18 shows a method for performing wireless communication by a first device, based on an embodiment of the present disclosure.

FIG. 19 shows a method for performing wireless communication by a second device, based on an embodiment of the present disclosure.

FIG. 20 shows a communication system 1, based on an embodiment of the present disclosure.

FIG. 21 shows wireless devices, based on an embodiment of the present disclosure.

FIG. 22 shows a signal process circuit for a transmission signal, based on an embodiment of the present disclosure.

FIG. 23 shows another example of a wireless device, based on an embodiment of the present disclosure.

FIG. 24 shows a hand-held device, based on an embodiment of the present disclosure.

FIG. 25 shows a vehicle or an autonomous vehicle, based on an embodiment of the present disclosure.

### MODE FOR INVENTION

In the present disclosure, “A or B” may mean “only A”, “only B” or “both A and B”. In other words, in the present disclosure, “A or B” may be interpreted as “A and/or B”. For example, in the present disclosure, “A, B or C” may mean “only A”, “only B”, “only C”, or “any combination of A, B and C”.

A slash (/) or comma used in the present disclosure may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B”, or “both A and B”. In addition, in the present disclosure, the expression “at least one of A or B” or “at least one of A and/or B” may be interpreted as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

In addition, a parenthesis used in the present disclosure may mean “for example”. Specifically, when indicated as “control information (PDCCH)”, it may mean that “PDCCH” is proposed as an example of the “control information”. In other words, the “control information” of the present disclosure is not limited to “PDCCH”, and “PDCCH” may be proposed as an example of the “control information”. In addition, when indicated as “control information (i.e., PDCCH)”, it may also mean that “PDCCH” is proposed as an example of the “control information”.

In the following description, ‘when, if, or in case of may be replaced with ‘based on’.

A technical feature described individually in one figure in the present disclosure may be individually implemented, or may be simultaneously implemented.

In the present disclosure, a higher layer parameter may be a parameter which is configured, pre-configured or pre-defined for a UE. For example, a base station or a network may transmit the higher layer parameter to the UE. For example, the higher layer parameter may be transmitted through radio resource control (RRC) signaling or medium access control (MAC) signaling.

In the present disclosure, “configure/configured or define/defined” may be interpreted as being configured or pre-configured for a device through pre-defined signaling (e.g., SIB, MAC, RRC) from a base station or a network. In the present disclosure, “configure/configured or define/defined” may be interpreted as being pre-configured for a device.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802-20, evolved UTRA (E-UTRA), long term evolution (LTE), 5G NR, and so on.

The technology proposed in the present disclosure may be implemented as 6G wireless technology and may be applied to various 6G systems. For example, the 6G system may have key factors such as enhanced mobile broadband (eMBB), ultra-reliable low latency communications (URLLC), massive machine type communications (mMTC), artificial intelligence (AI) integrated communication, tactile internet, high throughput, high network capacity, high energy efficiency, low backhaul and access network congestion, and enhanced data security.

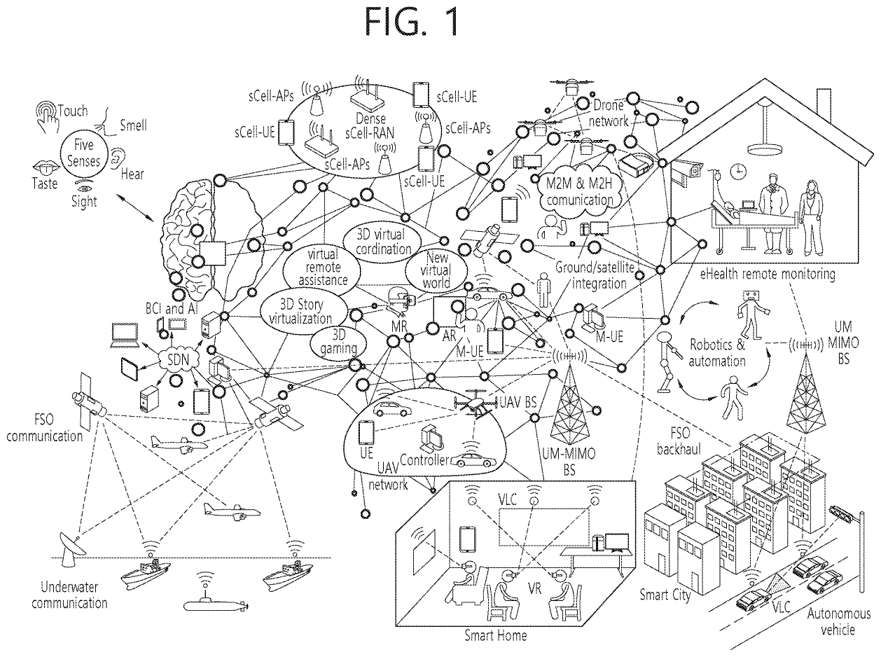

FIG. 1 shows a communication structure providable in a 6G system, based on an embodiment of the present disclosure. The embodiment of FIG. 1 may be combined with various embodiments of the present disclosure.

In 6G, new network characteristics may be as follows.
Satellites integrated network
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer
Ubiquitous super 3-dimension connectivity: Access to networks and core network functions of drones and very low earth orbit satellites will establish super 3D connection in 6G ubiquitous.

In the new network characteristics of 6G, several general requirements may be as follows.
Small cell networks
Ultra-dense heterogeneous network
High-capacity backhaul
Radar technology integrated with mobile technology: High-precision localization (or location-based service) through communication is one of the functions of the 6G wireless communication system. Accordingly, the radar system will be integrated with the 6G network.
Softwarization and virtualization

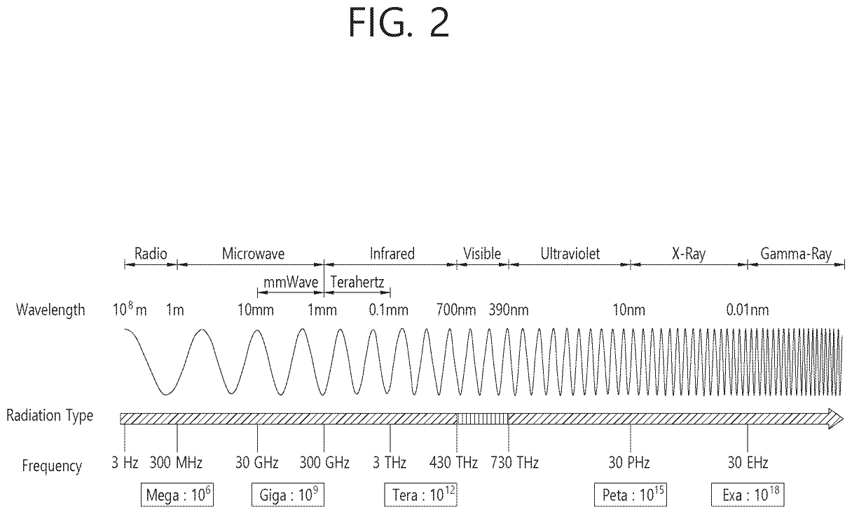

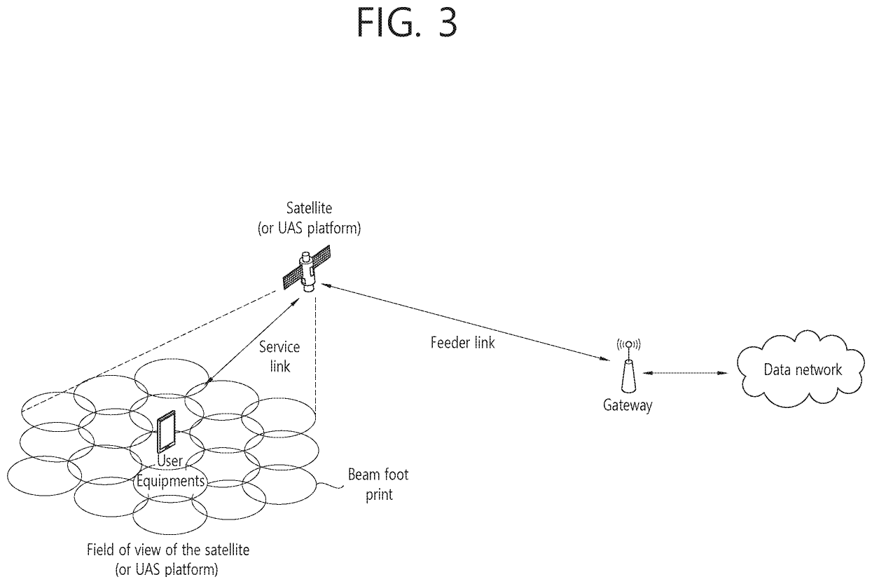

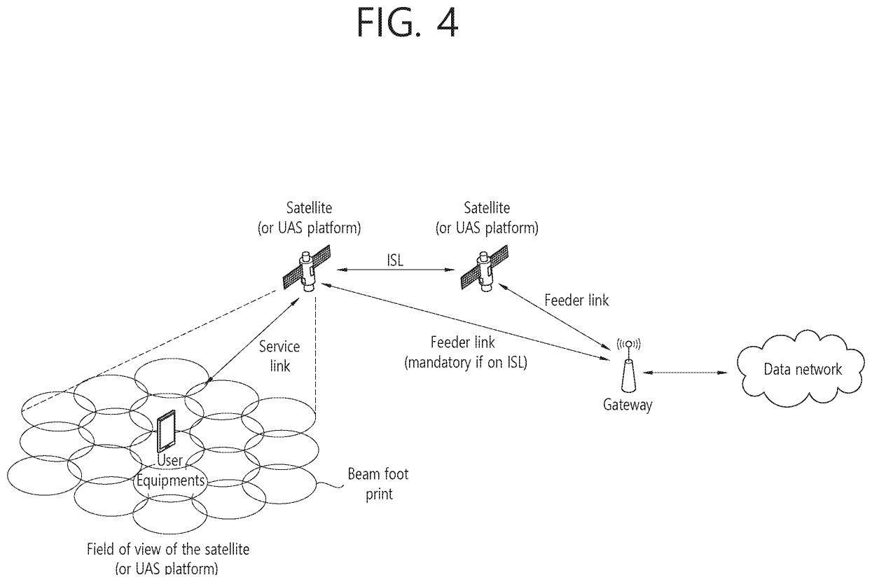

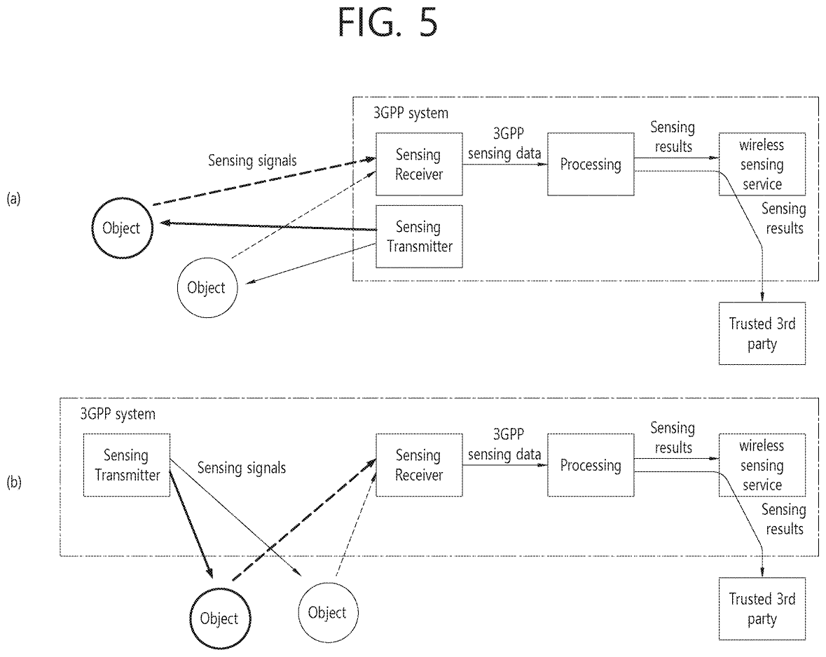

Core implementation technology of 6G system is described below.
Artificial Intelligence (AI): When AI is introduced to communication, real-time data transmission may be simplified and improved. AI may determine a method of performing complicated target tasks using countless analysis. That is, AI may increase efficiency and reduce processing delay. Operation consuming time such as handover, network selection, and resource scheduling immediately performed by using AI. AI may also play an important role in M2M, machine-to-human, and human-to-machine. In addition, AI may be a prompt communication in brain computer interface (BCI). An AI based communication system may be supported by metamaterial, intelligence structure, intelligence network, intelligence device, intelligence cognitive radio, self-maintaining wireless network, and machine learning.
Terahertz (THz) communication: A data rate may increase by increasing bandwidth. This may be performed by using sub-TH communication with wide bandwidth and applying advanced massive MIMO technology. THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF. FIG. 2 shows an electromagnetic spectrum, based on an embodiment of the present disclosure. The embodiment of FIG. 2 may be combined with various embodiments of the present disclosure. The main characteristics of THz communication include (i) bandwidth widely available to support a very high data rate and (ii) high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band. Therefore, an advanced adaptive arrangement technology capable of overcoming a range limitation may be used.
Massive MIMO technology (large-scale MIMO)
Hologram beamforming (HBF)
Optical wireless technology
Free space optical (FSO) backhaul network
Quantum communication
Cell-free communication
Integration of wireless information and power transmission
Integration of wireless communication and sensing
Integrated access and backhaul network
Big data analysis
Reconfigurable intelligent surface
Metaverse
Block-chain
Unmanned aerial vehicle (UAV): An UAV or a drone will be an important factor in 6G wireless communication. In most cases, a high-speed data wireless connection may be provided using UAV technology. A base station (BS) entity may be installed in the UAV to provide cellular connectivity. The UAV may have certain features, which are not found in fixed BS infrastructures, such as easy deployment, strong line-of-sight links, and mobility-controlled degrees of freedom. During emergencies such as natural disasters, the deployment of terrestrial telecommunications infrastructure is not economically feasible and sometimes services cannot be provided in volatile environments. The UAV can easily handle this situation. The UAV will be a new paradigm in the field of wireless communication. This technology facilitates the three basic requirements of wireless networks, such as eMBB, URLLC and mMTC. The UAV can also serve a number of purposes, such as network connectivity improvement, fire detection, disaster emergency services, security and surveillance, pollution monitoring, parking monitoring, and accident monitoring. Therefore, UAV technology is recognized as one of the most important technologies for 6G communication.
Advanced air mobility (AAM): An AAM is a superordinate concept of urban air mobility (UAM), which is air transportation that can be used in an urban area, and may refer to a means of transportation that includes movement between the urban area and a regional hub.
Autonomous driving (self-driving): Vehicle to everything (V2X) that is a core element for establishing an autonomous driving infrastructure may be a technology that vehicle communicates and shares with various elements in road for autonomous driving such as vehicle to vehicle (V2V), vehicle to infrastructure (V2I), and so on. To maximize a performance of autonomous driving and to secure high safety, high transmission speed and low latency technology have to be needed. Furthermore, in the future, autonomous driving may need to go beyond delivering warnings or guidance messages to drivers and actively intervene in vehicle operation and directly control the vehicle in dangerous situations. To this end, since the amount of information that needs to be transmitted and received may be enormous, autonomous driving is expected to be maximized in 6G being higher transmission speed and lower latency than 5G.
Non-terrestrial networks (NTN): An NTN may refer to a network or a network segment that utilizes radio frequency (RF) resources aboard a satellite (or an unmanned aerial system (UAS) platform). FIG. 3 shows an example of an NTN typical scenario based on a transparent payload, based on an embodiment of the present disclosure. FIG. 4 shows an example of an NTN typical scenario based on a regenerative payload, based on an embodiment of the present disclosure. The embodiment of FIG. 3 or FIG. 4 may be combined with various embodiments of the present disclosure. Referring to FIG. 3, a satellite (or an UAS platform) may establish a service link with a UE. The satellite (or the UAS platform) may be connected with a gateway through a feeder link. The satellite may be connected with a data network through the gateway. A beam footprint may refer to an area where signals transmitted by the satellite can be received. Referring to FIG. 4, a satellite (or an UAS platform) may establish a service link with a UE. The satellite (or the UAS platform) connected with the UE may be connected with another satellite (or another UAS platform) through an inter-satellite link (ISL). Another satellite (or another UAS platform) may be connected with a gateway through a feeder link. Based on the regenerative payload, the satellite may be connected with a data network through the gateway and another satellite. If the ISL does not exist between the satellite and another satellite, a feeder link between the satellite and the gateway may be required. FIGS. 3 and 4 are only examples of NTN scenarios, and the NTN can be implemented based on various types of scenarios. For example, the satellite (or the UAS platform) may implement a transparent or regenerative (with on board processing) payload. For example, the satellite (or the UAS platform) may generate multiple beams over a specified service area based on the field of view of the satellite (or the UAS platform). For example, the field of view of the satellite (or the UAS platform) may vary depending on an on-board antenna diagram and a minimum elevation angle. For example, the transparent payload may include radio frequency filtering, frequency conversion, and amplification. Therefore, the waveform signal repeated by the payload may not be changed. For example, the regenerative payload may include radio frequency filtering, frequency conversion and amplification, demodulation/decryption, switching and/or routing, and coding/modulation. For example, the regenerative payload may be substantially equivalent to equipping the satellite (or the UAS platform) with all or part of the base station functionality.
Integrated sensing and communication (ISAC): Wireless sensing is a technology enabler to acquire information about characteristics of the environment and/or objects within the environment, that uses radio frequency to determine the distance (range), angle, or instantaneous linear velocity of objects, etc. Radio frequency sensing functionality can provide services for device-free object localization as there is lack of need for the object to be connected via a device in the network. The capabilities to obtain range, velocity, and angle information from the radio frequency signals can provide a broad range of new functionality, such as various objects detection, object recognition (e.g., vehicle, human, animal, UAV) and high accuracy localization, tracking and activity recognition. For example, the wireless sensing service may provide input to different verticals (e.g., unmanned aerial vehicle, smart home, V2X, factories, railways, public safety, etc.) enabling applications offering e.g., intruder detection, assisted automotive maneuvering and navigation, trajectory tracing, collision avoidance, traffic management, health and activity monitoring. In some cases, wireless sensing can also use non-3GPP type sensors (e.g., radar, camera) to further support the 3GPP-based sensing. For example, the operation of the wireless sensing service, i.e., sensing operation, may rely on processing the transmissions, reflections, and scattering of wireless sensing signals. Wireless sensing, therefore, may have the opportunity to enhance the legacy system from a communication network to a wireless communication and sensing network. FIG. 5 shows an example of a sensing operation, based on an embodiment of the present disclosure. The embodiment of FIG. 5 may be combined with various embodiments of the present disclosure. Specifically, (a) of FIG. 5 shows an example of sensing (e.g., monostatic sensing) with co-located sensing receiver and sensing transmitter, and (b) of FIG. 5 shows an example of sensing (e.g., bistatic sensing) with separated sensing receiver and sensing transmitter.

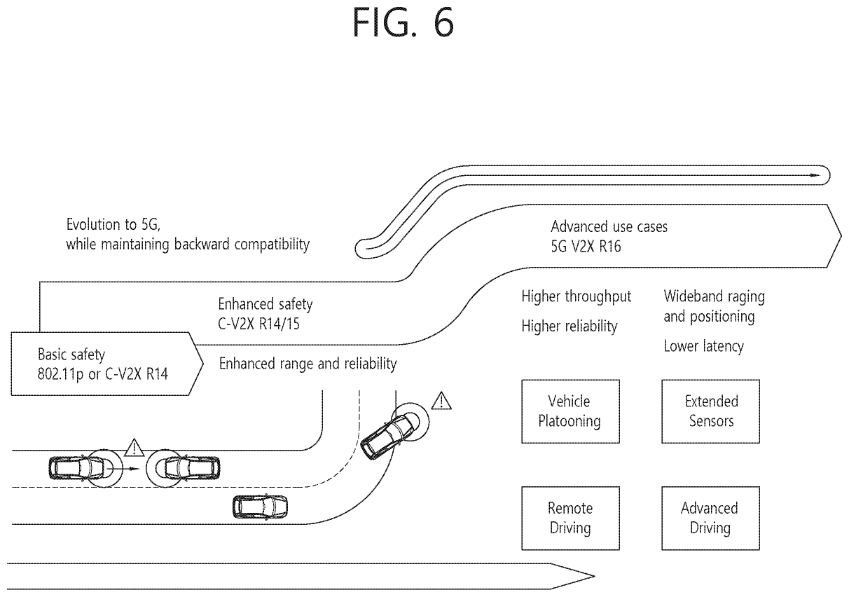

FIG. 6 is a drawing for describing V2X communication based on NR, compared to V2X communication based on RAT used before NR, based on an embodiment of the present disclosure. The embodiment of FIG. 6 may be combined with various embodiments of the present disclosure.

Regarding V2X communication, a scheme of providing a safety service, based on a V2X message such as Basic Safety Message (BSM), Cooperative Awareness Message (CAM), and Decentralized Environmental Notification Message (DENM) is focused in the discussion on the RAT used before the NR. The V2X message may include position information, dynamic information, attribute information, or the like. For example, a UE may transmit a periodic message type CAM and/or an event triggered message type DENM to another UE.

For example, the CAM may include dynamic state information of the vehicle such as direction and speed, static data of the vehicle such as a size, and basic vehicle information such as an exterior illumination state, route details, or the like. For example, the UE may broadcast the CAM, and latency of the CAM may be less than 100 ms. For example, the UE may generate the DENM and transmit it to another UE in an unexpected situation such as a vehicle breakdown, accident, or the like. For example, all vehicles within a transmission range of the UE may receive the CAM and/or the DENM. In this case, the DENM may have a higher priority than the CAM.

Thereafter, regarding V2X communication, various V2X scenarios are proposed in NR. For example, the various V2X scenarios may include vehicle platooning, advanced driving, extended sensors, remote driving, or the like.

For example, based on the vehicle platooning, vehicles may move together by dynamically forming a group. For example, in order to perform platoon operations based on the vehicle platooning, the vehicles belonging to the group may receive periodic data from a leading vehicle. For example, the vehicles belonging to the group may decrease or increase an interval between the vehicles by using the periodic data.

For example, based on the advanced driving, the vehicle may be semi-automated or fully automated. For example, each vehicle may adjust trajectories or maneuvers, based on data obtained from a local sensor of a proximity vehicle and/or a proximity logical entity. In addition, for example, each vehicle may share driving intention with proximity vehicles.

For example, based on the extended sensors, raw data, processed data, or live video data obtained through the local sensors may be exchanged between a vehicle, a logical entity, a UE of pedestrians, and/or a V2X application server. Therefore, for example, the vehicle may recognize a more improved environment than an environment in which a self-sensor is used for detection.

For example, based on the remote driving, for a person who cannot drive or a remote vehicle in a dangerous environment, a remote driver or a V2X application may operate or control the remote vehicle. For example, if a route is predictable such as public transportation, cloud computing based driving may be used for the operation or control of the remote vehicle. In addition, for example, an access for a cloud-based back-end service platform may be considered for the remote driving.

Meanwhile, a scheme of specifying service requirements for various V2X scenarios such as vehicle platooning, advanced driving, extended sensors, remote driving, or the like is discussed in NR-based V2X communication.

The present disclosure may relate to a method of transmitting a signal to restrict passage of a specific vehicle if necessary for safe passage at an intersection or the like, or generating a virtual object and transmitting a message related thereto.

Based on an embodiment of the present disclosure, whether a vehicle on a roadway passes through an intersection may be determined by a signal indication state of a traffic light or a traffic state of preceding vehicles or the like. For example, in relation to the signal indication state of the traffic light, if the traffic light is green (passable) and there is not much distance left until entering the intersection, the vehicle may pass through as it is, and if the traffic light is in a state of changing to red before entering the intersection (e.g., a yellow signal), it may be an example in which the vehicle does not pass through. However, for example, if an attempt to pass through is made only based on the condition of the signal indication state of the traffic light, since the traffic state of preceding vehicles or the like may not be considered, the vehicle may not be able to normally pass through the intersection, and this may interfere with passage of other vehicles or cause an accident.

Based on an embodiment of the present disclosure, in order to solve such a problem, if a basis or a guide capable of allowing surrounding vehicles to determine whether passage is possible is provided based on not only the signal indication state of a traffic light but also a vehicle traffic state, it may be more helpful for traffic safety.

Based on an embodiment of the present disclosure, when types of vehicles passing through an intersection are examined, they may be classified into vehicles that have already passed through the intersection and moved to a next road (i.e., a first vehicle), vehicles that have entered the intersection and are passing through (i.e., a second vehicle), and vehicles before entering the intersection (i.e., a third vehicle).

For example, in the case of the first vehicle, after passing over a certain area, it may not be necessary to transmit any signal or message related to intersection passage to following vehicles, or to have passage control involved.

For example, in the case of the second vehicle, the second vehicle may determine an operation by checking a state of the first vehicle, and/or may perform a procedure such as instructing or giving a guide related to an operation of the third vehicle. For example, if the second vehicle subsequently enters a certain area and may be classified as a vehicle of the same type as the first vehicle, it may no longer need to be involved in the intersection traffic.

For example, in the case of the third vehicle, whether passage is possible may be determined by a judgment considering states of the first vehicle, the second vehicle. For example, this may merely act as a recommendation to assist a final judgment of a driver, or, for example, may act as an obligation to induce more defensive driving. In particular, for example, in the case of an autonomous vehicle or the like, since a subjective judgment of the driver may not be included, a judgment considering the states of the first vehicle, the second vehicle and a signal/message, etc., based on that may be information actually recognized by the vehicle. Therefore, for example, it may need to avoid making judgments that are overly defensive (i.e. conservative) to the point of impeding the flow of traffic.

However, for example, if viewed in terms of an overall flow of traffic, merely being able to effectively prevent tailgating or the like at an intersection may contribute to improving traffic efficiency and reducing a risk of traffic accidents.

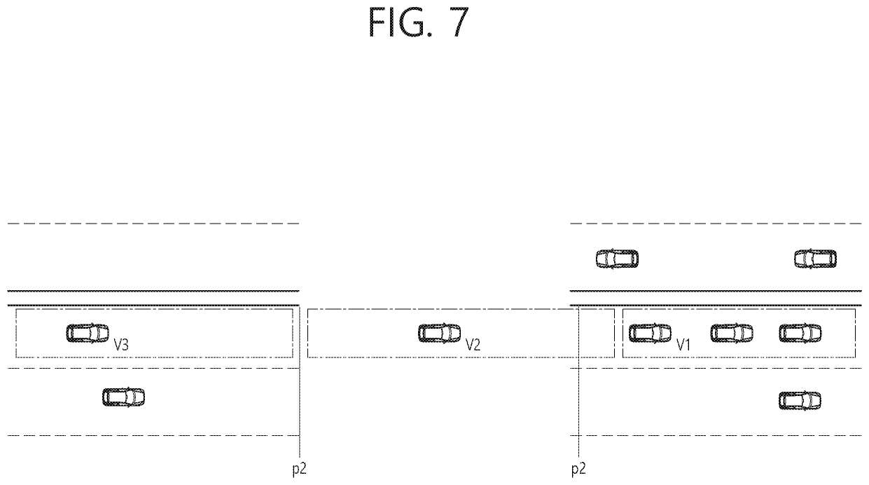

FIG. 7 shows an example of a method for determining whether passage through an intersection section is possible, based on an embodiment of the present disclosure. The embodiment of FIG. 7 may be combined with various embodiments of the present disclosure.

Referring to FIG. 7, based on an embodiment of the present disclosure, for example, if passing through an intersection section in a straight line (e.g., as in FIG. 7), a first vehicle (V1) may be in a state of having passed a point P2 on the opposite side of the intersection, and for example, a second vehicle (V2) may be located at some point on the intersection (between P1 and P2) or may be located between the point P2 and the first vehicle just after passing through the intersection. In addition, for example, a third vehicle (V3) may be in a state of not yet having reached an entry point P1 of the intersection.

For example, in this case, since the first vehicle has already passed through the intersection, it may no longer be necessary to be involved in intersection passage of following vehicles, however, operations of the second vehicle and the third vehicle may still be affected by an operation of the first vehicle. In particular, for example, the first vehicle may be affected by preceding vehicles that are further ahead, and for example, those preceding vehicles may also be affected by vehicles further ahead. Nevertheless, for example, the vehicle that has the greatest influence on the second vehicle and the third vehicle is the first vehicle, and it may be considered that an operation taken by the first vehicle is a result in which operations of the preceding vehicles are all reflected. Therefore, for example, it is possible to observe and obtain the mobility of the first vehicle, especially the position and velocity of the first vehicle, and in the case of velocity, determine whether it is driving at a constant speed/velocity or accelerating/decelerating.

For example, such information may be identified by the second vehicle or surrounding vehicles or the like, or, for example, a road side unit (RSU) installed at an intersection or the like may obtain the information through a message or a sensor or the like.

For example, position, velocity information of the second vehicle may also be identified by the third vehicle or surrounding vehicles or the like, or, for example, a road side unit (RSU) installed at an intersection or the like may obtain the information through a message or a sensor or the like. For example, in the case of the second vehicle, position, velocity information of the first vehicle and/or the third vehicle may be obtained directly or through surrounding vehicles, infrastructure, or a network or the like.

For example, position, velocity information of the third vehicle may be identified by the second vehicle or surrounding vehicles or the like, or, for example, a road side unit (RSU) installed at an intersection or the like may obtain the information through a message or a sensor or the like. For example, in the case of the third vehicle, position, velocity information of the second vehicle may be obtained directly or through surrounding vehicles, infrastructure, or a network or the like.

Additionally, for example, in the case of a traffic signal, a current state may be directly detected by each vehicle through a sensor, but for example, detailed states such as a remaining time of a current signal or the like may be obtained by infrastructure or a network related to the traffic light, for example, through a Signal Phase and Timing (SPaT) message or the like.

In the above, for example, whether to pass through an intersection or the like may be determined by a method of detecting a traffic light or the like in a vehicle and recognizing a shape of a road to determine that it is an intersection, or, for example, by providing information related to a position, size, area of the intersection or the like through infrastructure or a network or the like, for example, through a Map data Message (MAP) or the like, so that a passing vehicle determines whether the vehicle has entered the corresponding area. In addition, for example, a vehicle that first enters the intersection in the frontmost position may correspond to a role of the second vehicle (for example, being on the intersection section and having a preceding vehicle already passed through the intersection and existing ahead of P2), and, for example, in a case of a vehicle that is the rearmost among vehicles that have already passed through the intersection, for example, if there is no vehicle existing between a point P2 and its own position, it corresponds to a role of the first vehicle.

In addition, for example, if a vehicle has not yet entered the intersection but is the frontmost vehicle on the road, for example, if there is no vehicle existing between a point P1 and its own position, it corresponds to a role of the third vehicle.

However, for example, if no vehicle has entered the intersection, the vehicle that has not yet entered the intersection but is the frontmost vehicle on the road may temporarily or for a certain period of time perform a role of the second vehicle (for example, it may be done until there is a vehicle entering the intersection, or it may naturally continue to act as the role of the second vehicle as it enters the intersection), and in an embodiment(s) of the present disclosure, the second vehicle may determine not only whether the third vehicle may pass through but also whether the second vehicle itself may pass through the intersection through the same or similar criterion.

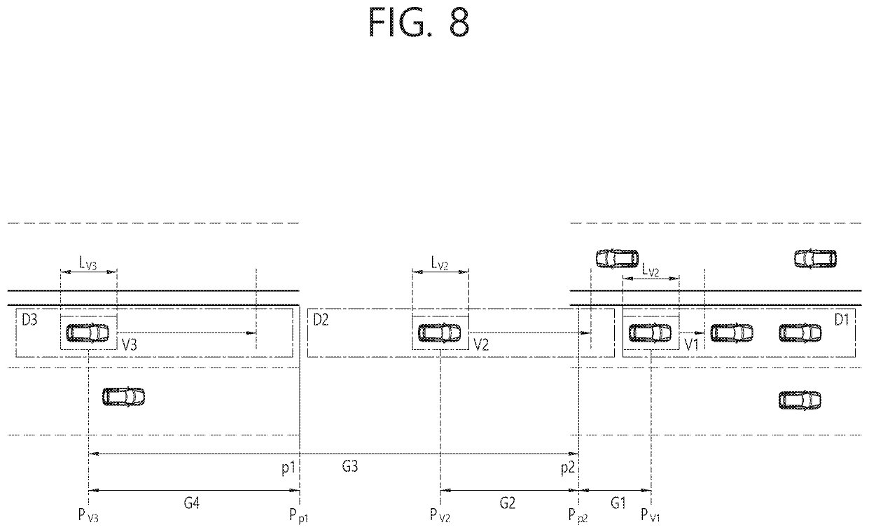

FIG. 8 shows an example of a method for determining whether passage through an intersection section is possible, based on an embodiment of the present disclosure. The embodiment of FIG. 8 may be combined with various embodiments of the present disclosure.

Referring to FIG. 8, based on an embodiment of the present disclosure, for example, when positions of the points P1, P2 are denoted as P_{P1}, P_{P2} (as shown in FIG. 8), and when a position of the first vehicle, particularly, for example, a position determined by setting a rear end point as a reference point, is denoted as P_{V1}, whether the second vehicle and the third vehicle have sufficient space to pass through the intersection may be determined based on how much free space remains between the position of the first vehicle and the point P2. For example, not only for the first vehicle but also for the second vehicle, the third vehicle, or the like, in order to determine whether each vehicle may pass through a specific point (for example, FIG. 8), a position of the vehicle may be set by using a rear end point as a reference point, and in some cases, for example, in embodiments determining whether a vehicle has reached or passed a stop line, a position of the vehicle may be set by using a front portion of the vehicle as a reference point.

For example, when a difference between distances of two points is denoted as P_{V1}−P_{P2}=G1 (as shown in FIG. 8), if this value is greater than areas occupied by the second vehicle and the third vehicle, it may be considered that both the second vehicle and the third vehicle satisfy a necessary condition for passing through the intersection. For example, when an area occupied by the second vehicle is denoted as L_{V2} and an area occupied by the third vehicle is denoted as L_{V3}, each value may be considered as a value obtained by adding a vehicle length or an additional margin, a safety distance (e.g., a minimum distance between vehicles at a stop, etc.), or the like. For example, for very precise control, these values may be set differently based on vehicle types, or for example, for simplicity, they may all (or certain vehicle groups) be set to have the same value. For example, most vehicles such as passenger cars, vans or the like except large cargo trucks may have a length of 9 m or less, and for example, large cargo trucks or buses or the like may have a length of about 9 m to 13 m. Therefore, for example, it may be simplified and represented as L_{type1}=9 m, L_{type2}=15 m, and for example, L_{V2}=L_{type1}, L_{V3}=L_{type1} may be substituted.

In addition, for example, L_{V2} may represent a length of a group of vehicles that are on an intersection in a specific lane, and for example, the second vehicle may refer to a vehicle(s) belonging to the group. For example, an order within the group, such as a frontmost vehicle or a rearmost vehicle of the group, may be easily identified through a message, sensing, or the like. As such, for example, L_{V2} may be identified by exchanging information of the frontmost and rearmost vehicles (or by collecting and analyzing the information).

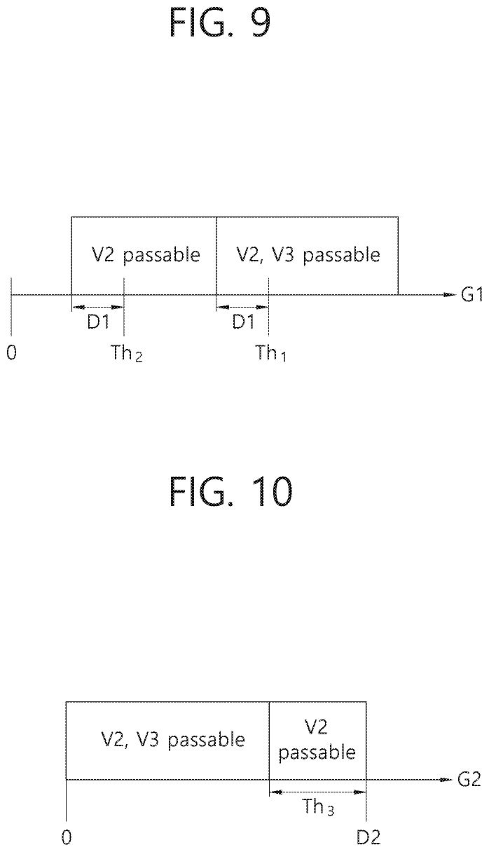

FIG. 9 shows an example of a method for determining whether passage through an intersection section is possible, based on an embodiment of the present disclosure. The embodiment of FIG. 9 may be combined with various embodiments of the present disclosure.

Referring to FIG. 9, based on an embodiment of the present disclosure, for example, if G1≥L_{V2}+L_{V3}, following vehicles (for example, the second vehicle and the third vehicle) may be in a state of being able to pass without a special condition (for example, except for whether a remaining time of a traffic signal exists or the like, when viewed in terms of a free space aspect), and here, for example, it may be represented as one threshold value (for example, L_{V2}+L_{V3}=Th₁).

For example, if the G1 value satisfies L_{V2}≤G1≤L_{V2}+L_{V3} (where L_{V2}=Th₂), the second vehicle may be able to pass (without any special conditions as above), and for example, the third vehicle may selectively be able to pass. For example, if the first vehicle continues to proceed and may secure sufficient space for the following third vehicle (or even vehicles thereafter), passage of the third vehicle (or even vehicles thereafter) may also be guaranteed. More specifically, for example, it may be to check whether the G1 value may expand to a value equal to or greater than L_{V2}+L_{V3} within a certain time. For example, in a situation where the velocity of the first vehicle is V_{V1}, the velocity may be maintained for a certain time (e.g., a remaining time of a green+yellow signal or a green signal of a first traffic light at P2), or for example, by accelerating, the G1 value may increase more rapidly, or for example, by sharply decelerating, the first vehicle may reach a stopped state.

For example, if the certain time is denoted as TREM, for example, if the first vehicle is driving at a constant speed/velocity VV1, the first vehicle may proceed by up to V_{V1}TREM, or for example, if the first vehicle is accelerating from the current velocity VV1 with an acceleration a0, it may proceed by V_{V1}TREM+(1/2)a₀T²REM. Meanwhile, for example, if the first vehicle is decelerating from the current velocity VV1 with an acceleration do (a negative value), it may proceed by V_{V1}T+(1/2)d₀T² (where T=min (T_{REM}, V_{V1}/|d₀|)). For example, if the moving distance is referred to as D1, if G1+D1≥L_{V2}+L_{V3}Th₁, both the second vehicle and the third vehicle may be able to pass, and otherwise (Th₂≤G1+D1<Th₁), only the second vehicle may be able to pass.

For example, if an exact mobility state of the first vehicle may not be identified, or for example, if an inaccurate value is expected, or for example, if a value of D1 is set to be as stable (conservative) as possible to ensure safer passage, D1 may be expressed as D1=V_{V1}T+(1/2)d_{MAX}T² (where T=min (T_{REM}, V_{V1}/|d_{MAX}|), and for example, d_{MAX} is the maximum deceleration value that is determined by vehicle specifications or is generally known/settable). For example, a value of TREM may represent a remaining time of a green signal for vehicle passage to ensure safe passage, but for example, in some cases (considering a situation in which a vehicle is already within an intersection during a yellow signal, etc.), it may be a concept including a remaining time of a green signal+an activation (or remaining) time of a yellow signal, or a remaining time of a yellow signal or the like. However, for example, a value of TREM may be a value unrelated to an activation/remaining time of a red signal for safety reasons.

Eventually, for example, (as described above) a passage-available range of the second vehicle and/or the third vehicle may expand by an additional moving distance of the first vehicle. For example, if the first vehicle is observed/reported to remain continuously stopped, the value D1 remains 0 while mobility of the first vehicle is not changing. For example, the possibility of passage of the second and third vehicles in relation to the free space at the rear of the first vehicle (above) may be summarized as in FIG. 9. For example, a velocity of the first vehicle may be mainly affected by a signal state of a second traffic light (for example, if a first traffic light exists at a position P2, the second traffic light may exist ahead of P2) and a maneuver based on thereto, which are related to preceding vehicles in the same lane, and for example, even if the vehicle is in a decelerating or stopped state rather than a state of continuously proceeding (constant speed/velocity or acceleration), variability of G1 may be predicted and applied based on a signal state (start of passage, during passage, stop of passage) of the second traffic light within the certain time (TREM).

For example, when the second traffic light indicates a stop of passage, a remaining time until a start of passage may be denoted as T_{REM,2}, and for example, if the passage starts, the first vehicle may sense/receive the number of preceding vehicles (n), a distance (L) from a preceding stop line, etc., or for example, it may be recognized by requesting and receiving feedback from infrastructure/network, etc.

For example, when vehicles after the second traffic light start to pass after the T_{REM,2}, as the passage of the queue continues, a time at which the first vehicle may start to move may be denoted as fi (n, L), and for example, an acceleration value of the first vehicle may be denoted as a₀, and for example, when the vehicle accelerates until reaching a certain velocity (e.g., a regulated velocity on a road the vehicle is on) (e.g., V_{MAX}=60 km/h) and then driving at a constant speed/velocity thereafter, the additional space that the first vehicle may secure by driving until then may be as shown in [Table 2].

TABLE 2

| | |
|---|---|
| 0 | T ≤ 0 |
| (½)a₀T² | 0 < T ≤ V_{MAX}/a₀ |
| V_{MAX}T − (V²_{MAX}/(2a₀)) | V_{MAX}/a₀ < T |

(T = T_{REM} − (T_{REM, 2} + f₁(n, L)))

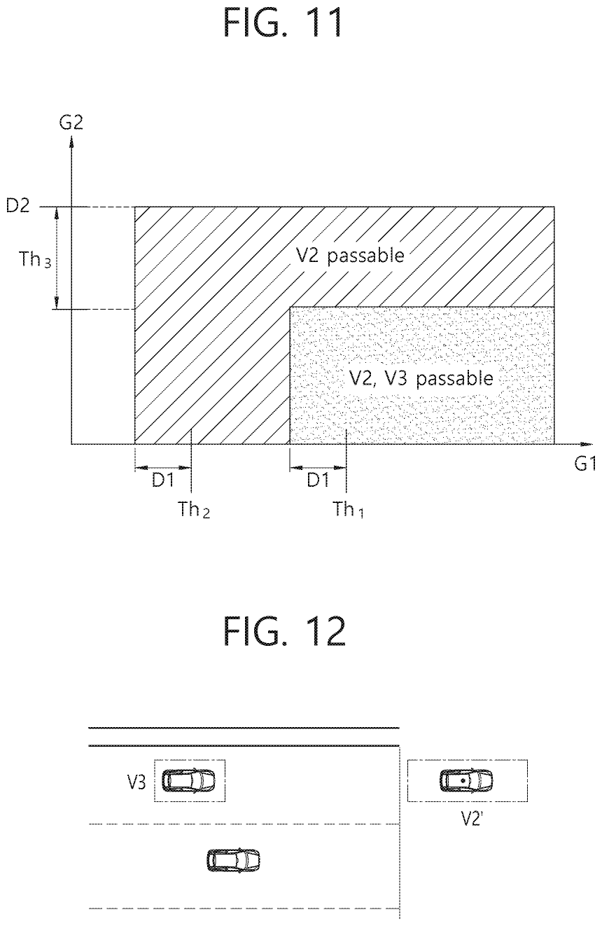

FIG. 10 and/or FIG. 11 show an example of a method for determining whether passage through an intersection section is possible, based on an embodiment of the present disclosure. The embodiments of FIG. 10 and/or FIG. 11 may be combined with various embodiments of the present disclosure.

Referring to FIG. 10 and/or FIG. 11, based on an embodiment of the present disclosure, for example, in the above, whether the first vehicle generates a free space by moving during a certain time was checked, and since the second vehicle is in a state of having entered the intersection, for example, it may also be checked how much the second vehicle may move during the same certain time, and thereafter, passage of the third vehicle may be controlled.

For example, under conditions for the free space being given, if the second vehicle may proceed L_{V3} or further than point P2 while the traffic signal (green light or a state in which a yellow light is activated based on a policy or situation, etc.) is activated, the third vehicle may be in a state of being able to pass without a problem. For example, when P_{P2}−P_{V2}=G2, it may be to determine whether this value is greater than a distance that the second vehicle may proceed or not.

For example, in a situation where the velocity of the second vehicle is V_{V2}, the velocity may be maintained for a certain time (e.g., a remaining time of a green light or a green+yellow light of a traffic signal), or for example, the second vehicle may sharply decelerate and reach a stopped state. For example, if the certain time is denoted as TREM, for example, if the second vehicle is driving at a constant speed/velocity V_{V2}, it may proceed by up to V_{V2}T_{REM}, or for example, if the second vehicle is accelerating from the current velocity V_{V2} with an acceleration a₀, it may proceed by V_{V2}T_{REM}+(1/2)a₀T²REM. Meanwhile, for example, if the second vehicle is decelerating from the current velocity V_{V2} with an acceleration do (a negative value), it may proceed by V_{V2}T+(1/2)d₀T² (where T=min (T_{REM}, V_{V2}/|d₀|)). For example, if the moving distance is referred to as D2, for example, if G2+L_{V3}≤D2 or G2≤D2−L_{V3}, both the second vehicle and the third vehicle may be able to pass, and otherwise (D2−L_{V3}<G2≤D2, where L_{V3}=Th₃), only the second vehicle may be able to pass.

For example, (as described above,) if an exact mobility state of the second vehicle may not be identified, or for example, if an inaccurate value is expected, or for example, to ensure safer passage, for example, if the second vehicle is passing at a very high velocity (e.g., higher than a regulated velocity on a road on which the second vehicle is driving), in order to prevent following vehicles from passing in accordance with that velocity, D2 may be set to be matched as D2=V_{MAX}T_{REM}. For example, VMAX may be a regulated velocity (e.g., 60 km/h) on the road or a value related thereto.

For example, (as described above,) if no vehicle has entered the intersection, it may be said that the vehicle that has not yet entered the intersection but is the frontmost vehicle on the road may temporarily or for a certain period of time perform a role of the second vehicle, and in this case, a value of G2 may become greater than a distance value between P2 and P1. For example, (even in such a case,) if the value D2 becomes equal to or greater than the value of such G2, at least the second vehicle may satisfy a condition of being allowed to pass through the intersection.

For example, whether the second vehicle and the third vehicle are able to pass in relation to a remaining time margin until the second vehicle passes through the intersection may be represented as shown in FIG. 10, and also, for example, together with whether the second vehicle, the third vehicle are able to pass in relation to a free space at the rear of the first vehicle, it may be represented as shown in FIG. 11.

For example, (for example, in FIG. 11), there may exist an area in which even the second vehicle may not pass, and in this case, the second vehicle may determine the situation by itself and take an action, or, for example, if the infrastructure or a network or the like determines this, it may directly transmit a corresponding message to the second vehicle, or, for example, may transmit a related message so that the second vehicle may perform a corresponding response operation.

For example, if the second vehicle may not pass due to a condition of G1, since the value of G1 is too small and tailgating may occur even if the intersection is passed, if the vehicle has not yet crossed the intersection, it may be allowed to drive only up to a position of P1 without passing through the intersection. And for example, if this condition (for example, the G1 condition) is released, for example, if it is determined that tailgating will not occur if the intersection is passed and, for example, if it is considered that sufficient space will be generated at the rear of the first vehicle, it may be allowed to determine whether to pass through the intersection by checking a condition of G2 or the like. For example, if the intersection has already been crossed, it may be allowed to drive up to the rear portion of the first vehicle and wait for a subsequent situation. Therefore, for example, if this condition (for example, the G1 condition) is released, it may be allowed to completely pass through the intersection beyond P2.

For example, if the second vehicle may not pass due to a condition of G2, since the value of G2 is too large and the intersection may not be passed within the remaining time, if the vehicle has not yet crossed the intersection, it may be allowed to drive only up to a position of P1 without passing through the intersection. For example, if the intersection has already been crossed, since it is highly likely that the traffic signal will not be obeyed anyway, giving a specific instruction or guide to the second vehicle may be meaningless. For example, if it is determined that stopping on the intersection is more dangerous, the vehicle may be allowed to continue driving without stopping, and for example, in some cases, the vehicle may be allowed to temporarily drive at a velocity higher than a regulated velocity (on the road on which the vehicle is driving) in order to pass through the intersection within a given time.

For example, (for example, in FIG. 11), there may exist an area in which only the second vehicle may pass (and/or the third vehicle may not pass), and in this case, the second vehicle or infrastructure/a network or the like may recognize and determine this, and for example, may directly transmit a corresponding message to the third vehicle, or for example, may transmit a related message so that the third vehicle may perform a corresponding response operation. For example, if the third vehicle may not pass due to a condition of G1, since the value of G1 is still small and tailgating may occur due to the third vehicle even if the intersection is passed, the third vehicle may be allowed not to pass through the intersection and to drive only up to a position of P1. And for example, if this condition is released, the second vehicle or infrastructure/a network or the like may additionally check a condition of G2 or the like to determine whether it is a situation in which the third vehicle may pass through the intersection, and for example, may directly transmit a corresponding message to the third vehicle, or may transmit a related message so that the third vehicle may perform a corresponding response operation.

For example, the third vehicle may determine whether it may pass through the intersection by comparing a remaining time of a traffic signal with a distance to the point P2 (G3), based on a current velocity or a regulated velocity, etc.

FIGS. 12, 13, 14, and/or 15 show an example of information included in a message, based on an embodiment of the present disclosure. The embodiments of FIGS. 12, 13, 14, and/or 15 may be combined with various embodiments of the present disclosure.

Referring to FIGS. 12, 13, 14, and/or 15, based on an embodiment of the present disclosure, for example, a message related to passage of the third vehicle may be generated in the second vehicle or in infrastructure/a network, and for example, when the message related to passage of the third vehicle is generated in the second vehicle or in the infrastructure/the network, corresponding passage control information may be added to a basic safety message (BSM) (first message), or for example, may be generated as a separate basic safety message (BSM)/other vehicle-to-everything (V2X) message (e.g., Intelligent Transport Systems (ITS) message (Cooperative Awareness Message, Decentralized Environmental Notification Message, MAP Message, Signal Phase and Timing Message, etc.)) (second message) and transmitted.

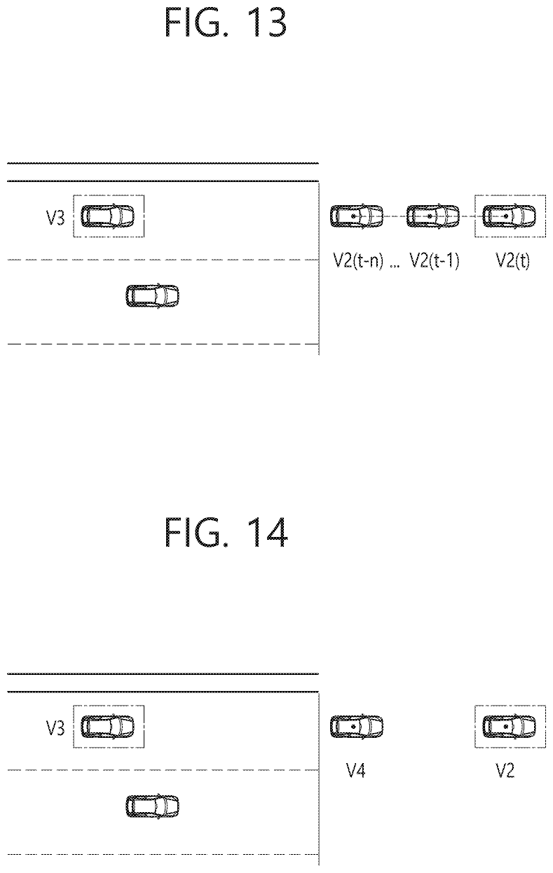

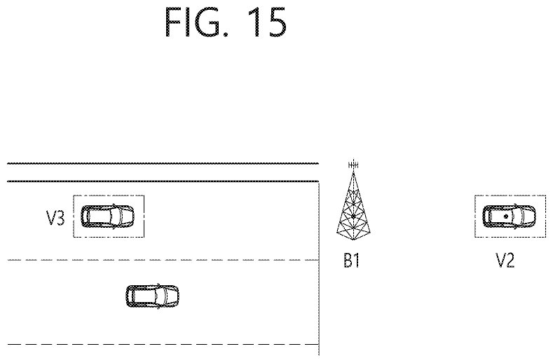

For example, in the message(s), in order to control passage of the third vehicle, actual vehicle states may be combined, modified, or transformed to generate new types of vehicle information, mobility information, etc. For example, if there exist multiple vehicles corresponding to the second vehicle, which is a preceding vehicle of the third vehicle, those vehicles may be generated as one group, and group information thereof may be transmitted. For example, if driving in a group form or driving alone, if the vehicle or at least one vehicle in the group, for example, the second vehicle, has already passed and intersection, the information of the second vehicle may be modified, transformed, or new information may be added so that the third vehicle may not follow the second vehicle and drive, for example, so that the third vehicle has no choice but to stop. For example, a form of the added information may be at least one of the following specific embodiments.
vehicle form: For example, as shown in FIG. 12, it may be represented in a form in which a length of the second vehicle or a group of the second vehicles is extended (a kind of virtual tail form) to block passage of the third vehicle. Or, for example, as shown in FIG. 13, it may be in a form in which a part or one or more points of an existing path history continue to remain for a certain time. Or, for example, instead of generating information in a form related to the second vehicle or in another form of a virtual vehicle, information may be generated in the form of a virtual vehicle as shown in FIG. 14 or in the form of a virtual obstacle, a barricade as shown in FIG. 15 to block passage of the third vehicle.
Reference point of position information: For example, (as described above,) a reference point of additional information other than vehicle information may be a specific point related to a path history of the second vehicle or a specific point between points P1 and P2. For example, particularly, it is preferable that a position of a reference point of the virtual tail, virtual vehicle, or virtual barricade or the like be close to P1 so that the third vehicle is prevented from passing beyond P1.
Vehicle size (length): For example, a length of the object may be in a form in which the second vehicle or a group of the second vehicles is extended as shown in FIG. 15 to a specific point (closer to P1) between points P1 and P2, or, for example, may be in a form of a virtual vehicle corresponding to a separate fourth vehicle as shown in FIG. 14, or in a form of a first obstacle as shown in FIG. 15, occupying a length of a general vehicle or an area corresponding thereto by LV4, or may be an object corresponding to an obstacle, a barricade occupying an area LB1.
Mobility: For example, a mobility of the object may be such that it maintains the mobility information of a second vehicle or a group of second vehicles, or, for example, it may be such that it is slow (e.g., compared to a second vehicle, etc.) or stationary with no mobility in order to prevent the approach of a third vehicle, etc. following behind.
Passability: For example, the first vehicle may sense/measure/calculate/predict the free space between P2 and the first vehicle and indicate whether the following vehicle may pass. For example, in this case, only the passability of the following vehicle may be represented and/or information related to the free space (G1) between P2 and the first vehicle may be transmitted together.

For example, if no vehicle is sensed/detected on the intersection, i.e., between P1 and P2, the first vehicle may indicate whether the following vehicle behind P1 may pass. For example, in this case, the passage of the third vehicle behind P1 may be controlled by the second vehicle, not the first vehicle. For example, this may only represent whether the following vehicle may pass and/or may transmit information related to the free space (G1) between P2 and the first vehicle. Additionally, for example, it may transmit information including the remaining time until the stop signal of the first traffic light (T_{REM}) and/or information about G3 (or G4).

For example, the vehicle behind P1 may, of course, directly determine whether it may pass as a second vehicle by considering the above conditions. For example, in this case, the second vehicle may transmit virtual information (e.g., tail, vehicle, obstacle, barrier) that controls the passage of the following vehicle, similar to the role of the second vehicle mentioned above.

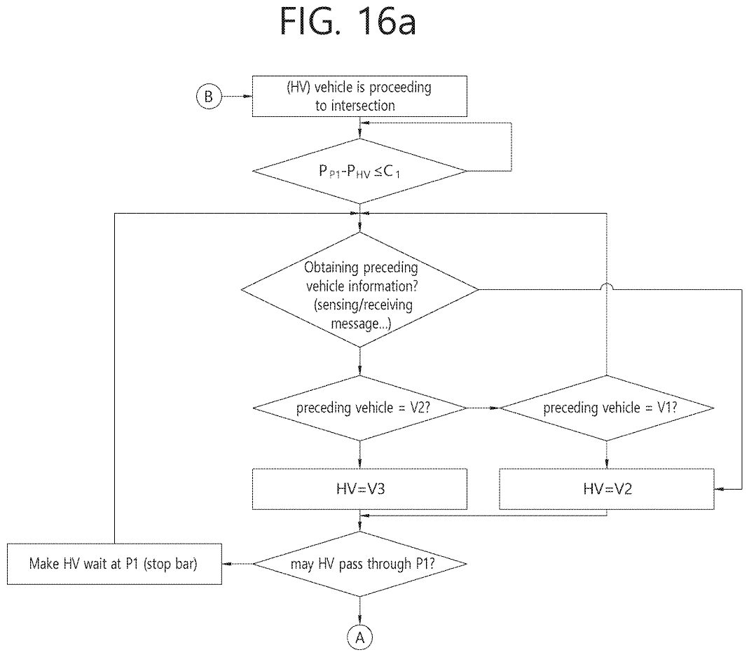

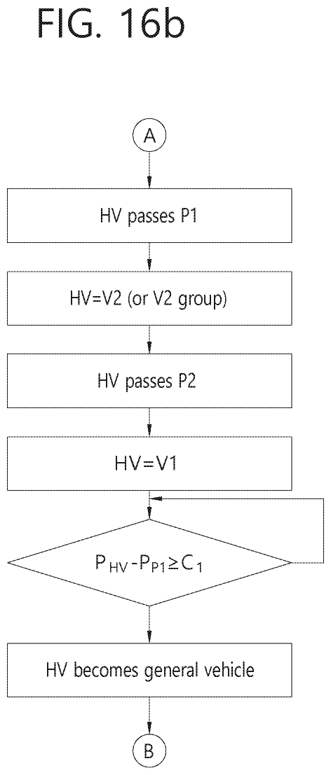

FIG. 16 (FIG. 16a, FIG. 16b) show an example of a method for controlling maneuver within an intersection based on a message, based on an embodiment of the present disclosure. The embodiment of FIG. 16 (FIG. 16a, FIG. 16b) may be combined with various embodiments of the present disclosure.

Referring to FIG. 16 (FIG. 16a, FIG. 16b), based on an embodiment of the present disclosure, for example, the above method(s) are intended for vehicles proceeding at an intersection (or other places where traffic lights, etc. are installed for vehicle traffic control), etc., and may start with a specific vehicle (Host Vehicle (HV)) attempting to enter the intersection (as in FIG. 16) in a state where it is a general vehicle that is not classified as a first vehicle to a third vehicle, etc. For example, the intersection information may be known in advance, or may be information that is periodically transmitted to vehicles within the coverage of the infrastructure/network, by the infrastructure/network or the like around the intersection, for example.

For example, the series of process(es) of FIG. 16 is such that in a situation where the Host Vehicle (HV) is obtaining intersection information as described above, for example, if there is a certain distance left until entering the intersection (point P1) (e.g., before entering the intersection C1 (m)), the above/below action(s) are triggered, and it is checked periodically (or at a given point) whether (additional) information related to intersection traffic control is obtained, and then the next action(s) may be determined. For example, more specifically, the Host Vehicle (HV) may sense the preceding vehicle on its own, or, for example, may recognize it by receiving a message, etc., or, for example, may discover it by combining each method(s) or other methods.

For example, if the preceding vehicle is identified as a general vehicle other than the first to third vehicles, or as a third vehicle, normal driving may be carried out without being affected by the traffic control, and, for example, the preceding vehicle information may be continuously updated.

For example, a vehicle satisfying the second vehicle condition among preceding vehicles may be sensed/discovered (a preceding vehicle passing through or approaching the intersection may also be recognized while recognizing the intersection), or, for example, a message about the second vehicle may be obtained from the second vehicle (e.g., the second vehicle itself may directly advertise, or the message may include content referring to the second vehicle, or the application (layer) may determine it), or, for example, a message about the second vehicle may be obtained from the infrastructure/network, or, for example, a message received from the second vehicle, the infrastructure/network may be processed at the application (layer) level to confirm the existence of the second vehicle, or, for example, a Host Vehicle (HV) may become a third vehicle and, for example, may operate based on instructions, guides, etc. to be taken as a third vehicle, or, for example, an indicator of a third vehicle may be indicated in a specific field of a message (e.g., a basic safety message (BSM)) or a new message (intersection crossing).

Additionally, for example, a message/information related to whether the intersection may be passed, for example, whether P1 may be passed, may be received through the second vehicle or infrastructure/network, etc., and, for example, accordingly, the vehicle may pass through P1 or stop and wait for the next signal.

For example, more specifically, if the passage condition is not met during a green (or yellow) light state, it may wait at the stop line as a third vehicle, or, for example, if a passable condition is determined, it may pass through P1 (e.g., become the second vehicle or belong to a group of second vehicles) and pass to point P2. For example, since the red light itself does not establish the conditions for passage, it may wait at the stop line as a third vehicle.

For example, (in the above), a Host Vehicle (HV) may wait based on traffic conditions or signals while the preceding vehicles continue to proceed and may exit the intersection (point P2), and, for example, the status of the Host Vehicle (HV) vehicle may change to a second vehicle.

For example, if a vehicle satisfying the second vehicle condition among preceding vehicles may not be sensed/discovered, a message for the second vehicle may not be received through surrounding vehicles, infrastructure/network, etc., and the existence of the second vehicle may not be confirmed even after processing a message received from surrounding vehicles or infrastructure/network, the Host Vehicle (HV) may become the second vehicle (possibly even before point P1), and for example, an indicator that it is the second vehicle may be indicated in a specific field of a (e.g., basic safety message (BSM)) message or a new (intersection crossing) message.

For example, if the Host Vehicle (HV) becomes the second vehicle before point P1, similar to the third vehicle, the ability to pass through point P1 may be determined based on traffic conditions under green/yellow/red signal conditions. For example, if the vehicle is not able to pass through, it may wait while checking and updating the status of the preceding vehicle. For example, if the vehicle is able to pass through, it may proceed to point P2.

For example, if the Host Vehicle (HV) becomes the second vehicle after point P1, or if it maintains the second vehicle after point P1, it may still be allowed to pass to point P2.

For example, upon passing P1, it may change to belong to a second vehicle or a group of second vehicles (for example, if there is a second vehicle(s) remaining that is ahead and has not yet reached P2), for example, an indicator of a second vehicle may be indicated in a specific field of a message (e.g., a basic safety message (BSM)) or a new message (intersection crossing). For example, if there is only one second vehicle, it may monitor the preceding first vehicle and the following third vehicle, update and transmit the values of various parameters (e.g., obtain variables G1, D1, G2, D2, and constants Th1, Th2), for example, directly indicate whether the third vehicle may pass, or, for example, transmit a message while creating a virtual object (a virtual vehicle with an extended tail, a virtual barrier that may block the passage of the third vehicle) as needed. For example, if there are multiple second vehicles, and the vehicle is at the front/back (for example, each front/back vehicle may drive while indicating whether it is the front/back vehicle of the group), a representative vehicle (e.g., the frot vehicle) in charge of transmitting traffic information may collect information from the remaining vehicles (e.g., the rear vehicles) to generate the virtual object information and transmit the message. For example, the virtual object information generation performed by the second vehicle or the representative vehicle of the second vehicles may be performed in the infrastructure/network.

For example, the Host Vehicle (HV) may become the first vehicle when it passes point P2, and for example, an indicator of the first vehicle may be indicated in a specific field of an existing (e.g., basic safety message (BSM)) message or a new (intersection crossing) message.

For example, if the first vehicle moves away from point P2 by a certain distance (e.g., 20 m) or a new vehicle is discovered between point P2 and the first vehicle, the vehicle may be changed to a normal vehicle instead of the first vehicle. For example, a separate indicator for a normal vehicle may not be necessary, and for example, a message (e.g., basic safety message (BSM)) may be transmitted as is.

For example, if a vehicle is not sensed/discovered on the intersection, i.e., between P1 and P2, the passage of a third vehicle behind P1 as a second vehicle, not the first vehicle, may be controlled. At this time, only the passage of the following vehicle may be represented, and/or, for example, information for the free space (G1) between P2 and the first vehicle may be transmitted together, and, for example, information on the remaining time until a stop signal of the first traffic light (T_{REM}) and/or information on G3 (or G4) may be additionally transmitted. For example, of course, a vehicle behind P1 as the second vehicle may directly determine its own passage availability in consideration of the above condition(s).

In an embodiment(s) of the present disclosure, for example, an awareness state, a maneuver negotiation state, and a maneuver execution state may be defined. For example, in the awareness state, it may be assumed that a Host Vehicle (HV) has sufficient environmental awareness through a Basic Safety Message (BSM). For example, the Host Vehicle (HV) may have additional information through Sensor Data Sharing Messages (SDSM) and/or maneuver intent and may use this to enter the maneuver negotiation state. For example, in the maneuver negotiation state, the Host Vehicle (HV) may need to send a Maneuver Sharing and Coordinating Message (MSCM) including message type 1, “Maneuver Request,” to all Remote Vehicles (RVs) to share its intended maneuver. For example, all Remote Vehicles (RVs) that have received the “Maneuver Request” may need to respond to the Host Vehicle (HV) with an MSCM using message type 2, “Maneuver Response,” to represent acceptance or rejection of the received Maneuver Request no later than T_1. For example, if the Host Vehicle (HV) accepts the maneuver request from all Remote Vehicles (RVs) within T_1, the maneuver request may be considered approved. Otherwise, the maneuver request may be considered rejected. For example, if the “Maneuver Request” is approved, the Host Vehicle (HV) may need to send an MSCM including message type 3, “Maneuver Reservation,” to all Remote Vehicles (RVs) by T_2. For example, in the maneuver execution state, the Host Vehicle (HV) and the Remote Vehicle (RV) may move appropriately based on the approved maneuver (e.g., maneuver reservation). For example, if the approved maneuver is completely executed, the Host Vehicle (HV) and the Remote Vehicle (RV) may return to the awareness state.

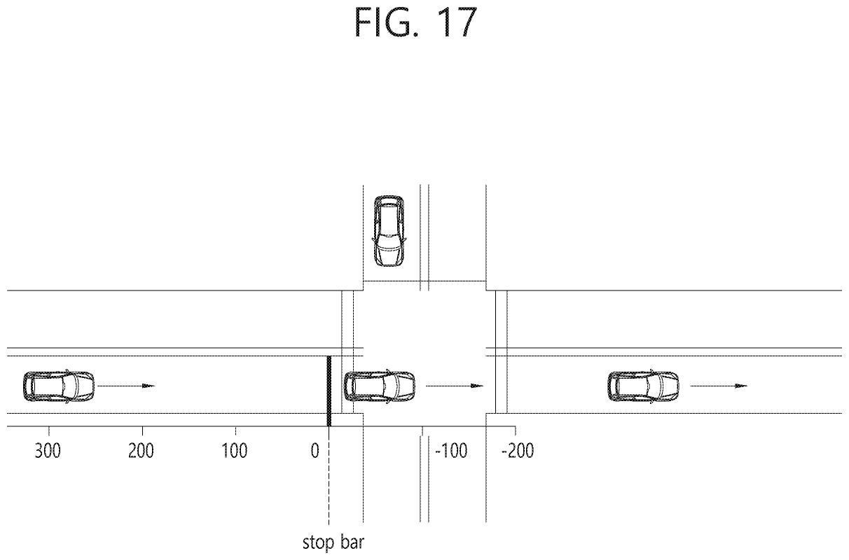

FIG. 17 shows an example of a method for controlling maneuvers within an intersection based on messages, based on an embodiment of the present disclosure. The embodiment of FIG. 17 may be combined with various embodiments of the present disclosure.

Referring to FIG. 17, based on an embodiment of the present disclosure, there may be a vehicle that has passed an intersection (hereinafter referred to as a first vehicle), a vehicle that is passing through the intersection (hereinafter referred to as a second vehicle), and/or a vehicle positioned before a stop bar to pass through the intersection (hereinafter referred to as a third vehicle). For example, each traffic light arranged on each road (lane) of the intersection may generate, at a certain time at regular intervals, a signal for controlling the passage of the vehicles toward the vehicles arranged on each road (lane) of the intersection. For example, the third vehicle may determine/judge whether the intersection is passable based on information related to the distance to the stop bar and information related to the remaining time until the first traffic light on the road of the third vehicle changes its signal (e.g., green→yellow, yellow→red, red→red+left turn signal (right turn signal), red+left turn signal (right turn signal)→green). For example, let's assume that the third vehicle is currently located 300 meters before the stop bar. Also, for example, if the speed limit in the section that the third vehicle is in is 50 m/s, the signal of the first traffic light is currently green, the remaining time for the signal to change from green to yellow is 5 seconds, and the length of the section to pass through the intersection is 150 meters, it may take at least 9 seconds ((300+150)/50) for the third vehicle to pass through the intersection, which is greater than the remaining time, so it may be determined/judged that the third vehicle may not pass through the intersection. Conversely, let's assume that the third vehicle is currently located 50 meters before the stop bar. And, similarly, for example, if the speed limit in the section that the third vehicle is in is 50 m/s, the signal of the current first traffic light is green, the remaining time for the signal to change from green to yellow is 5 seconds, and the length of the section to pass the intersection is 150 m, then it may take at least 4 seconds ((50+150)/50) for the third vehicle to pass the intersection, which is less than the remaining time, and therefore the third vehicle may determine/judge that it may pass the intersection. To implement this, the third vehicle may perform, stop, or cancel a maneuver (reservation) for moving beyond the intersection (e.g., deceleration, constant speed/velocity, acceleration, lane change, lane merge, etc. for movement to a target point).

However, for example, if the distance between the third vehicle and the second vehicle at the very front of the third vehicle is not sufficiently large, the determination related to whether the intersection is passable may be incorrect. In particular, for example, even if the third vehicle may receive information related to the distance between the third vehicle and the second vehicle, and information related to the speed of the second vehicle at a specific time, the determination related to whether the intersection is passable may be incorrect because the speed/acceleration/path history of the second vehicle before and after the specific time, and the time taken for the second vehicle to pass through the intersection, etc. are not known. In addition, for example, even if the third vehicle may receive information related to the distance between the third vehicle and the second vehicle, and information related to the speed of the second vehicle at a specific time, if the distance between the first vehicle at the very front of the second vehicle is not sufficiently large, the determination related to whether the intersection is passable may be incorrect. For example, since the speed/acceleration/path history of the first vehicle before and after a specific time, and the time it takes for the first vehicle to leave the intersection, etc., are unknown, the determination related to whether the intersection is passable may be incorrect.

To address these issue(s), information related to an area in which the second vehicle and/or the first vehicle will additionally move for a certain period of time after a certain point in time (e.g., future free moving distance of the second vehicle and/or the first vehicle during the remaining time until the signal changes, future free moving section of the second vehicle and/or the first vehicle, future free gap between the second vehicle and/or the first vehicle, etc.) may be generated and/or transmitted and received. For example, based on the information, a message related to the execution or suspension or cancellation of a maneuver (reservation) (e.g., deceleration, constant speed/velocity, acceleration, lane change, lane merge, etc. for movement to a target point) of the first vehicle, the second vehicle, and/or the third vehicle may be generated and/or transmitted and received. For example, based on the information, maneuvers (reservations) of the first vehicle, the second vehicle, and/or the third vehicle (e.g., deceleration, constant speed/velocity, acceleration, lane change, lane merge, etc. for movement to a target point) may be performed, stopped, or canceled.

Based on an embodiment of the present disclosure, for example, by sharing information related to the future free space in addition to a current inter-vehicle distance of a preceding vehicle and/or a preceding-preceding vehicle, a rear vehicle, which is unaware of the traffic situation ahead, may maintain a safe distance from the preceding vehicle. For example, by determining whether to drive (autonomously) based on information related to the future free space of the preceding vehicle and/or the preceding-preceding vehicle, accidents may be preemptively prevented.

In the present disclosure, an entity may mean a physical entity having the same configuration/function/role as the first device (part of), the second device (part of), and/or the first device/second device (part of), or a logical entity performing the same configuration/function/role as the first device/second device, as defined below.

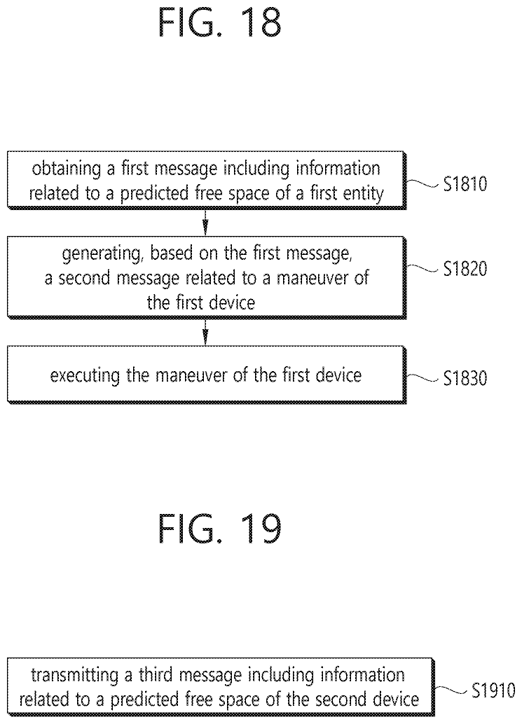

FIG. 18 shows a method for a first device to perform wireless communication based on an embodiment of the present disclosure. The embodiment of FIG. 18 may be combined with various embodiments of the present disclosure.

Referring to FIG. 18, based on an embodiment of the present disclosure, in step S1810, for example, the first device may obtain a first message including information related to the predicted free space of the first entity. In step S1820, for example, the first device may generate a second message related to a maneuver of the first device based on the first message. In step S1830, for example, the first device may execute the maneuver of the first device.

Additionally, or alternatively, the first entity may include a first-front entity that is frontmost in a direction of movement of the first device.

Additionally, or alternatively, the first entity may include a second-front entity that is in front of the first-front entity that is frontmost in the direction of movement of the first device.

Additionally, or alternatively, the information related to the predicted free space of the first entity may include information related to a predicted free distance based on a first time, a first velocity of the first entity, and a first acceleration of the first entity.

Additionally, or alternatively, the first time may include the remaining time until a phase of a traffic light within a zone to which the first entity or the first device belongs is switched.

Additionally, or alternatively, the first velocity may include a velocity threshold within a zone to which the first entity belongs.

Additionally, or alternatively, the first acceleration may include a maximum acceleration of the first entity.

Additionally, or alternatively, the information related to the predicted free space of the first entity may include information related to a predicted free section based on the first time, the first velocity of the first entity, and the first acceleration of the first entity.

Additionally, or alternatively, the first message may include a vehicle-to-everything (V2X) message.

Additionally, or alternatively, the V2X message may include a basic safety message (BSM).

Additionally, or alternatively, the first message may further include information related to a length of the first entity.

Additionally, or alternatively, the first message may further include information related to a path history of the first entity.

Additionally, or alternatively, the first message may further include information related to a virtual entity between the first device and the first entity.

Additionally, or alternatively, the first message may further include information related to a reference position of the first entity.

Additionally, or alternatively, the second message may include information related to a reservation for maneuver of the first device.

The proposed method can be applied to devices based on various embodiments of the present disclosure. First, the memory 104 of the first device 100 may store instructions that, based on being executed by the processor 102, cause the first device (e.g., the processor 102, the transceiver 106) to perform operations. For example, the operations may comprise at least one of: obtaining a first message including information related to a predicted free space of a first entity; generating a second message related to a maneuver of the first device based on the first message; and/or executing the maneuver of the first device.

In an embodiment, a first device adapted to perform wireless communication is provided. The first device may comprise: at least one transceiver; at least one processor; and at least one memory connected to the at least one processor and storing instructions that, based on being executed by the at least one processor, cause the first device to perform operations. For example, the operations may comprise at least one of: obtaining a first message including information related to a predicted free space of a first entity; generating a second message related to a maneuver of the first device based on the first message; and/or executing the maneuver of the first device.

In an embodiment, a processing device adapted to control a first device is provided. For example, the processing device may comprise: at least one processor; and at least one memory connected to the at least one processor and storing instructions that, based on being executed by the at least one processor, cause the first device to perform operations. For example, the operations may comprise at least one of: obtaining a first message including information related to a predicted free space of a first entity; generating a second message related to a maneuver of the first device based on the first message; and/or executing the maneuver of the first device.

In an embodiment, a non-transitory computer-readable storage medium storing instructions is provided. The instructions, when executed, may cause a first device to perform operations. For example, the operations may comprise at least one of: obtaining a first message including information related to a predicted free space of a first entity; generating a second message related to a maneuver of the first device based on the first message; and/or executing the maneuver of the first device.

FIG. 19 shows a method for a second device to perform wireless communication based on an embodiment of the present disclosure. The embodiment of FIG. 19 may be combined with various embodiments of the present disclosure.

Referring to FIG. 19, based on an embodiment of the present disclosure, in step S1910, for example, the second device may transmit a third message including information related to the predicted free space of the second device. Based on the third message, a second message related to a maneuver of the first device may be generated. The maneuver of the second device may be executed.

Additionally, or alternatively, the first entity may include a first-front entity that is frontmost in a direction of movement of the first device.

Additionally, or alternatively, the first entity may include a second-front entity that is in front of the first-front entity that is frontmost in the direction of movement of the first device.

Additionally, or alternatively, the information related to the predicted free space of the first entity may include information related to a predicted free distance based on a first time, a first velocity of the first entity, and a first acceleration of the first entity.

Additionally, or alternatively, the first time may include the remaining time until the phase of a traffic light within a zone to which the first entity or the first device belongs is switched.

Additionally, or alternatively, the first velocity may include a velocity threshold within a zone to which the first entity belongs.

Additionally, or alternatively, the first acceleration may include a maximum acceleration of the first entity.

Additionally, or alternatively, the information related to the predicted free space of the first entity may include information related to a predicted free section based on the first time, the first velocity of the first entity, and the first acceleration of the first entity.

Additionally, or alternatively, the first message may include a vehicle-to-everything (V2X) message.

Additionally, or alternatively, the V2X message may include a basic safety message (BSM).

Additionally, or alternatively, the first message may further include information related to a length of the first entity.

Additionally, or alternatively, the first message may further include information related to a path history of the first entity.

Additionally, or alternatively, the first message may further include information related to a virtual entity between the first device and the first entity.

Additionally, or alternatively, the first message may further include information related to a reference position of the first entity.

Additionally, or alternatively, the third message may include information related to a reservation for maneuver of the second device.

The proposed method can be applied to devices based on various embodiments of the present disclosure. First, the memory 204 of the second device 200 may store instructions that, based on being executed by the processor 202, cause the second device (e.g., the processor 202, the transceiver 206) to perform operations. For example, the operations may comprise at least one of: transmitting a third message including information related to a predicted free space of the second device; wherein, based on the third message, a second message related to a maneuver of the first device may be generated, and/or the maneuver of the first device may be executed.

In an embodiment, a second device adapted to perform wireless communication is provided. For example, the second device may comprise: at least one transceiver; at least one processor; and at least one memory connected to the at least one processor and storing instructions that, based on being executed by the at least one processor, cause the second device to perform operations. For example, the operations may comprise at least one of: transmitting a third message including information related to a predicted free space of the second device; wherein, based on the third message, a second message related to a maneuver of the first device may be generated, and/or the maneuver of the first device may be executed.

In an embodiment, a processing device adapted to control a second device is provided. For example, the processing device may comprise: at least one processor; and at least one memory connected to the at least one processor and storing instructions that, based on being executed by the at least one processor, cause the second device to perform operations. For example, the operations may comprise at least one of: transmitting a third message including information related to a predicted free space of the second device; wherein, based on the third message, a second message related to a maneuver of the first device may be generated, and/or the maneuver of the first device may be executed.

In an embodiment, a non-transitory computer-readable storage medium storing instructions is provided. The instructions, when executed, may cause a second device to perform operations. For example, the operations may comprise at least one of: transmitting a third message including information related to a predicted free space of the second device; wherein, based on the third message, a second message related to a maneuver of the first device may be generated, and/or the maneuver of the first device may be executed.

Various embodiments of the present disclosure may be combined with each other.

Hereinafter, device(s) to which various embodiments of the present disclosure can be applied will be described.

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

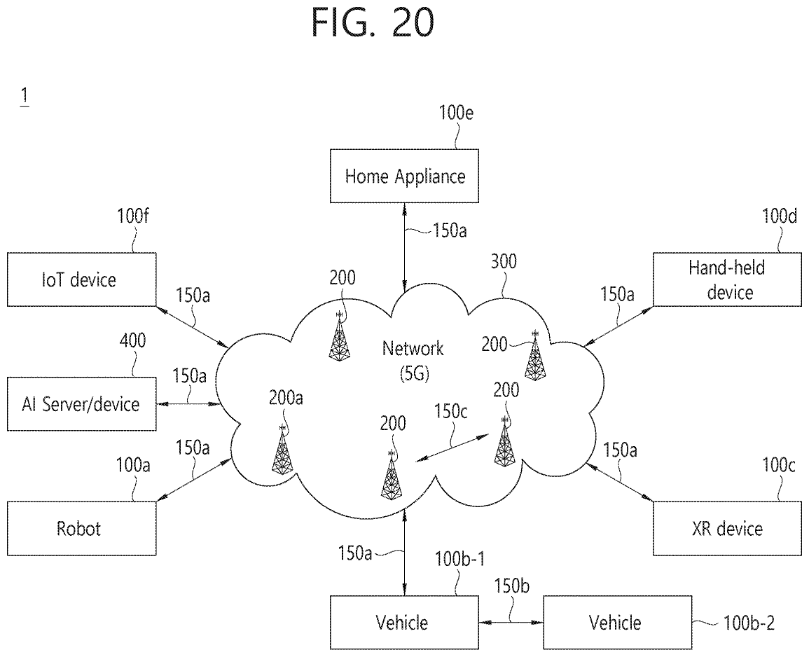

FIG. 20 shows a communication system 1, based on an embodiment of the present disclosure. The embodiment of FIG. 20 may be combined with various embodiments of the present disclosure.

Referring to FIG. 20, a communication system 1 to which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone) and/or an Aerial Vehicle (AV) (e.g., Advanced Air Mobility (AAM)). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

Here, wireless communication technology implemented in wireless devices 100a to 100f of the present disclosure may include Narrowband Internet of Things for low-power communication in addition to LTE, NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices 100a to 100f of the present disclosure may perform communication based on LTE-M technology. In this case, as an example, the LTE-M technology may be an example of the LPWAN and may be called by various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, and is not limited to the name described above. Additionally or alternatively, the wireless communication technology implemented in the wireless devices 100a to 100f of the present disclosure may include at least one of Bluetooth, Low Power Wide Area Network (LPWAN), and ZigBee considering the low-power communication, and is not limited to the name described above. As an example, the ZigBee technology may generate personal area networks (PAN) related to small/low-power digital communication based on various standards including IEEE 802.15.4, and the like, and may be called by various names.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

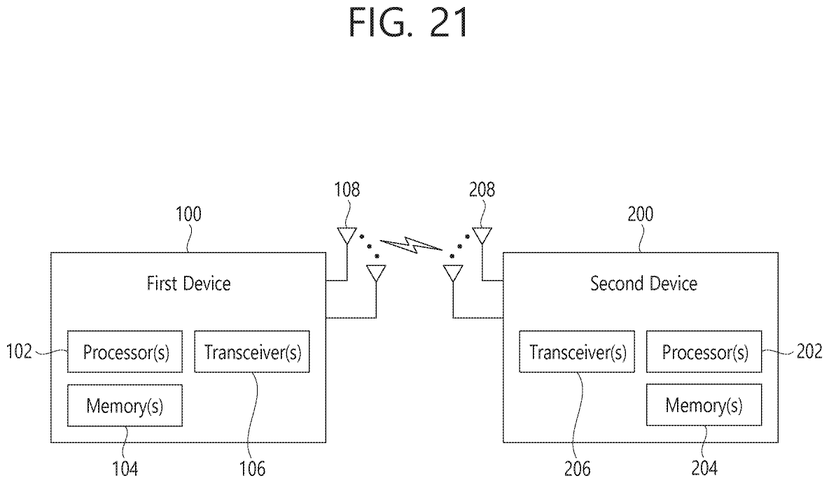

FIG. 21 shows wireless devices, based on an embodiment of the present disclosure. The embodiment of FIG. 21 may be combined with various embodiments of the present disclosure.

Referring to FIG. 21, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 20.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cache memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

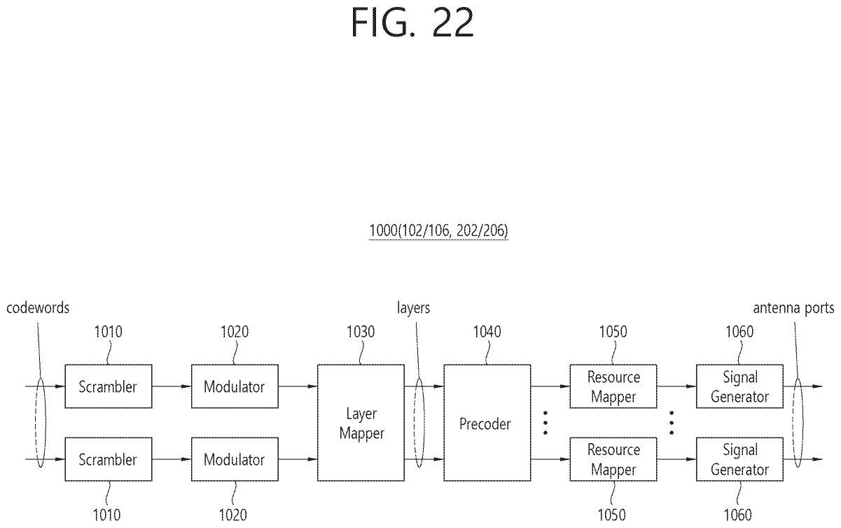

FIG. 22 shows a signal process circuit for a transmission signal, based on an embodiment of the present disclosure. The embodiment of FIG. 22 may be combined with various embodiments of the present disclosure.

Referring to FIG. 22, a signal processing circuit 1000 may include scramblers 1010, modulators 1020, a layer mapper 1030, a precoder 1040, resource mappers 1050, and signal generators 1060. An operation/function of FIG. 22 may be performed, without being limited to, the processors 102 and 202 and/or the transceivers 106 and 206 of FIG. 21. Hardware elements of FIG. 22 may be implemented by the processors 102 and 202 and/or the transceivers 106 and 206 of FIG. 21. For example, blocks 1010 to 1060 may be implemented by the processors 102 and 202 of FIG. 21. Alternatively, the blocks 1010 to 1050 may be implemented by the processors 102 and 202 of FIG. 21 and the block 1060 may be implemented by the transceivers 106 and 206 of FIG. 21.

Codewords may be converted into radio signals via the signal processing circuit 1000 of FIG. 22. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 22. For example, the wireless devices (e.g., 100 and 200 of FIG. 21) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

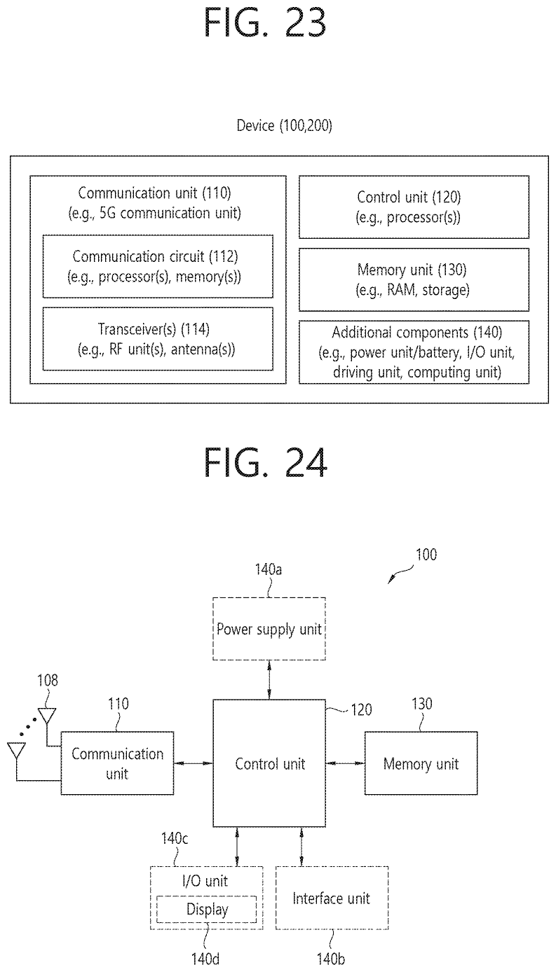

FIG. 23 shows another example of a wireless device, based on an embodiment of the present disclosure. The wireless device may be implemented in various forms according to a use-case/service (refer to FIG. 20). The embodiment of FIG. 23 may be combined with various embodiments of the present disclosure.

Referring to FIG. 23, wireless devices 100 and 200 may correspond to the wireless devices 100 and 200 of FIG. 21 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 21. For example, the transceiver(s) 114 may include the one or more transceivers 106 and 206 and/or the one or more antennas 108 and 208 of FIG. 21. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 20), the vehicles (100b-1 and 100b-2 of FIG. 20), the XR device (100c of FIG. 20), the hand-held device (100d of FIG. 20), the home appliance (100e of FIG. 20), the IoT device (100f of FIG. 20), a digital broadcast terminal, a hologram device, a public safety device, an MTC device, a medicine device, a fintech device (or a finance device), a security device, a climate/environment device, the AI server/device (400 of FIG. 20), the BSs (200 of FIG. 20), a network node, etc. The wireless device may be used in a mobile or fixed place according to a use-example/service.

In FIG. 23, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 23 will be described in detail with reference to the drawings.

FIG. 24 shows a hand-held device, based on an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT). The embodiment of FIG. 24 may be combined with various embodiments of the present disclosure.

Referring to FIG. 24, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to140c correspond to the blocks 110 to 130/140 of FIG. 23, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

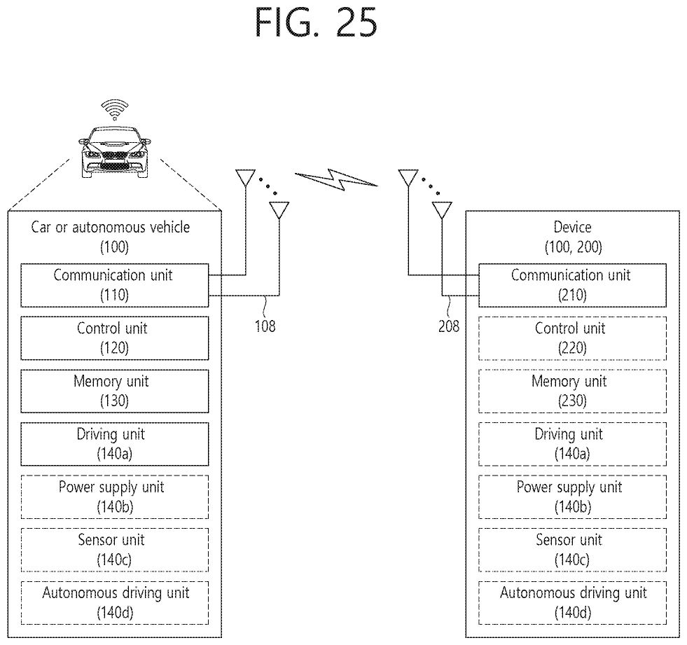

FIG. 25 shows a vehicle or an autonomous vehicle, based on an embodiment of the present disclosure. The vehicle or autonomous vehicle may be implemented by a mobile robot, a car, a train, a manned/unmanned Aerial Vehicle (AV), a ship, etc. The embodiment of FIG. 25 may be combined with various embodiments of the present disclosure.

Referring to FIG. 25, a vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 23, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous vehicle 100. The control unit 120 may include an Electronic Control Unit (ECU). The driving unit 140a may cause the vehicle or the autonomous vehicle 100 to drive on a road. The driving unit 140a may include an engine, a motor, a powertrain, a wheel, a brake, a steering device, etc. The power supply unit 140b may supply power to the vehicle or the autonomous vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method.

1. A method, comprising:
obtaining, by a first device, a first message including information related to a predicted free space of a first entity;
generating, by the first device, based on the first message, a second message related to a maneuver of the first device; and
executing, by the first device, the maneuver of the first device.

2. The method of claim 1, wherein the first entity includes a first-front entity that is frontmost in a direction of movement of the first device.

3. The method of claim 1, wherein the first entity includes a second-front entity that is located in front of a first-front entity that is frontmost in a direction of movement of the first device.

4. The method of claim 1, wherein the information related to the predicted free space of the first entity includes information related to a predicted free distance based on a first time, a first velocity of the first entity, and a first acceleration of the first entity.

5. The method of claim 4, wherein the first time includes a remaining time until a phase of a traffic light within a zone to which the first entity or the first device belongs is switched.

6. The method of claim 4, wherein the first velocity includes a velocity threshold within a zone to which the first entity belongs.

7. The method of claim 4, wherein the first acceleration includes a maximum acceleration of the first entity.

8. The method of claim 1, wherein the information related to the predicted free space of the first entity includes information related to a predicted free section based on a first time, a first velocity of the first entity, and a first acceleration of the first entity.

9. The method of claim 1, wherein the first message includes a vehicle-to-everything (V2X) message.

10. The method of claim 9, wherein the V2X message includes a basic safety message (BSM).

11. The method of claim 1, wherein the first message further includes information related to a length of the first entity.

12. The method of claim 1, wherein the first message further includes information related to a path history of the first entity.

13. The method of claim 1, wherein the first message further includes information related to a virtual entity between the first device and the first entity.

14. The method of claim 1, wherein the first message further includes information related to a reference position of the first entity.

15. The method of claim 1, wherein the second message includes information related to a reservation of the maneuver of the first device.

16. A first device, comprising:
at least one transceiver;
at least one processor; and
at least one memory connected to the at least one processor and storing instructions that, based on being executed by the at least one processor, cause the first device to perform operations comprising:
obtaining a first message including information related to a predicted free space of a first entity;
generating, based on the first message, a second message related to a maneuver of the first device; and
executing the maneuver of the first device.

17. A processing device, comprising:
at least one processor; and
at least one memory connected to the at least one processor and storing instructions that, based on being executed by the at least one processor, cause a first device to perform operations comprising:
obtaining a first message including information related to a predicted free space of a first entity;
generating, based on the first message, a second message related to a maneuver of the first device; and
executing the maneuver of the first device.

18-22. (canceled)
